(19) United States
(12) Patent Application Publication
(10) Pub. No.: US 2007/0033575 A1
(43) Pub. Date: Feb. 8, 2007

(54) Software for linking objects using an object-based interface

(76) Inventors: Davin Hills, West Des Moines, IA (US); Greg Goodrich, West Des Moines, IA (US); Joseph Tarbell, West Des Moines, IA (US)

Correspondence Address: Davis, Brown, Koehn, Shors & Roberts, P.C.;The Financial Center, Suite 2500, 666 Walnut Street, Des Moines, IA, 50309-3993, US

(21) Appl. No.: 11/497,756

(22) Filed: Aug. 2, 2006

Related U.S. Application Data
(60) Provisional application No. 60/704,823, filed on Aug. 2, 2005.

(51) Int. Cl. G06F 9/44

(52) U.S. Cl. 717/116

(57) ABSTRACT

An object-based computer software application for generating medical documents includes the use of metadata objects to represent user-interface components and medical objects based on the metadata objects. In addition, patient data objects are generated from medical objects as selected by a user. The metadata objects, medical objects and patient data objects are stored in and retrieved from a relational database. The application also makes use of a table structure of each of the three object components. The table structure includes a first table in which is stored the object and a second table in which is stored a plurality of properties associated with the object. Means is provided for linking a metadata object to one or more other objects creating linked objects such that the linked objects are launched automatically upon launch of the metadata object. In an alternative embodiment, the metadata object has one or more user-selected options that launch associated or linked objects only upon selection by the user.

This application claims priority to U.S. Patent Application Ser. No. 60/704,823 filed Aug. 2, 2005.

### BACKGROUND OF THE INVENTION

1. Field of the Invention

The invention relates generally to a computer software system for generating medical notes and, more specifically, to a computer software system for generating documents which comprise a patient file using an object-based interface and a method for linking objects to improve the functionality and efficiency of the medical note generating software.

2. Background of the Art

Providing medical care to patients involves the generation of large quantities of paper which comprise a patient's medical file. Typically, the patient file is created at the first visit of the patient to a treatment facility, such as a doctor's office, a clinic, a hospital, or the like. The file includes the patient's medical history, treatments, referring physician information, insurance information, current drugs prescribed, test results, diagnoses, X-rays and other image-based information, and notes taken by the healthcare professional to record information regarding the patient conditions, complaints, care instructions and the like. The patient file is updated whenever new information is received, such as upon a subsequent patient visit, the return of laboratory results, correspondence from a consulting physician, and so on. A patient's file will also contain copies of correspondence sent to a physician to which the patient has been referred.

Most healthcare providers still generate notes for patient files by either writing them on forms or in long-hand, or by dictating notes which are then transcribed by non-medical personnel. This process requires significant time by the healthcare provider and/or the cost of the employment of transcribers or a transcription service.

There have been many software systems developed and sold which assist the healthcare provider in generating and maintaining the patient files. One type of system uses voice recognition software to automatically transcribe dictated recordings of notes. While such software continues to improve, significant amounts of time must be spent in training the system and, even with much training, the software still makes errors that need to be corrected by human review.

Medical practitioners have highly individualized approaches to their medical practice and hence their preferred form of medical notes and the order and content of those notes is also highly individualized. Medical note generating software that allowed the user to customize the software to link features and objects of the software would improve the functionality and efficiency of the software for each user.

### SUMMARY OF THE INVENTION

The invention applies to a computer software system for generating medical documents for a patient medical file. The software system includes a user interface with a plurality of components selected by a healthcare provider for the entry of information to be included in the medical documents. The user interface components include metadata objects that relate to medical objects. The healthcare provider selects from the medical objects and the software system generates patient data objects which are added to the medical file of the patient. The software system includes a relational database which is used for storing and retrieving the metadata objects, the medical objects and the patient data objects. Each of the three object components are stored in a table structure wherein a first table stores the object and a second table stores a plurality of properties associated with the object.

According to the present invention, users of the software system customize the software by associating or linking objects so that one or more linked objects will launch automatically when the linking object is launched or in response to a choice made by the user in the linking object.

### BRIEF DESCRIPTION OF THE DRAWINGS

FIG. 1 is a schematic diagram showing the relationship between a user interface of the system and metadata objects, medical objects and patient data objects used in the system.

FIG. 2 is a sample dialog box that appears on the user interface when entering patient data concerning “pulses.”

FIG. 3 is a series of three dialog boxes opened by a user to enter patient data concerning skin conditions including acne, acne-aggravating factors, and current treatments.

FIG. 4 is view of the default Object Explorer dialog box.

FIG. 5 is a sample Object Editor dialog box that appears on the user interface when the user is linking an object to another object.

FIG. 6 a sample Find Object dialog box in which a search for available objects is conducted as the user types a search term in the Search Text box.

FIG. 7 shows the Object Editor dialog box of FIG. 5 after three linked objects, namely Ankle->conditions, Ankle stability exam, and Ankle->stability tests, have been selected by the user.

FIG. 8 is a sample Object Editor dialog box for linking the object Back Exam to any of the available choices.

FIG. 9 is the dialog box that is launched upon selection of the Advanced tab in the Object Editor dialog box of FIG. 8.

FIG. 10 is the Find Object dialog box that is launched upon selection of the New button in the Object Editor dialog box of FIG. 9.

FIG. 11 shows the Advanced dialog box of FIG. 9 after the selection of “Back Pain” and “Done” in the dialog box of FIG. 10.

FIG. 12 is a sample Chief Complain dialog box.

FIG. 13 shows the Object Editor dialog box for “Acne (CC)” wherein the Linked Object menu option under the Advanced tab has been selected.

FIG. 14 shows the Find Object dialog box listing all of the available objects beginning with the term “Acne.”

FIG. 15 is the Object Editor dialog box displayed after the selection of Acne-Aggravating Factors, Acne-Location, Acne-Current Treatment, and Acne-Treatment Side Effects in the Find Object Dialog box of FIG. 14.

### DETAILED DESCRIPTION OF THE PREFERRED EMBODIMENTS

The invention is a part of an object-oriented software application that produces medical documents using an object-based user interface and item/property data storage. Data storage is set up to store metadata objects, medical objects built on the metadata objects, and patient objects which are the output of the medical objects. A relational database is used to store and retrieve metadata objects, medical objects, and patient data objects. The table structure for the three object components is set up as two tables per object type. The first table stores the object and the second table stores the properties associated with the object.

Metadata objects are a description or definition of electronic data, or data about data, or information about information, and include information describing aspects of actual data items, such as name, format, content, and the control of or over data. Metadata objects comprise a structured set of descriptive elements to describe an information resource or, more generally, any definable entity. Metadata objects include Beginning Phrase, Minimum Value, Maximum Value, Increment, Bilateral, Units, and Default Value.

Medical objects are user interface components that describe or depict a medical attribute, location, or condition. Examples of medical objects include Beginning Phrase, Minimum Value, Maximum Value, Increment, Bilateral, Units, and Default Value.

Patient data objects are user interface components that associate a medical object with a particular patient.

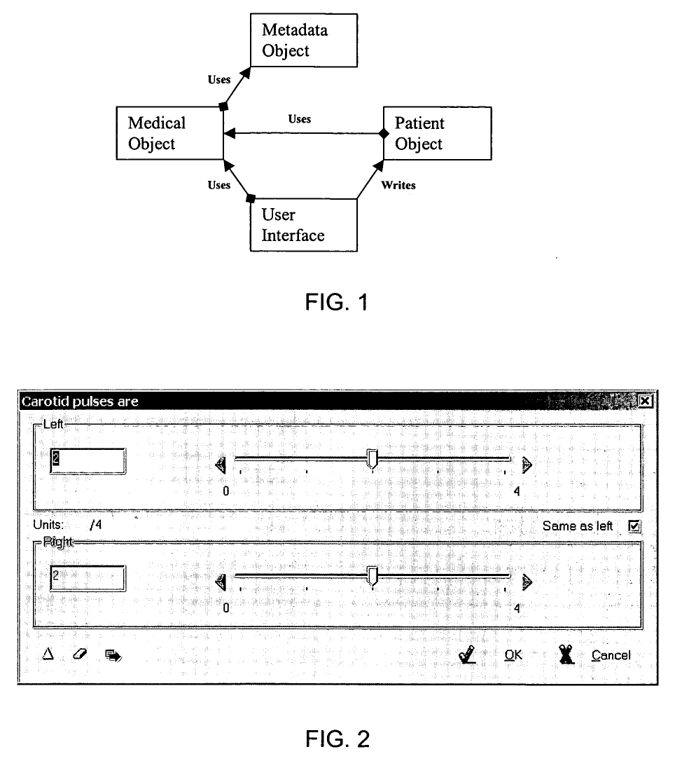

Metadata objects are used to represent user interface components. These user interface components are used to communicate medical thoughts or ideas. A schematic diagram of the user interface and the three types of objects is illustrated in FIG. 1. If, for example, a user interface component that represents a measurement would have a data structure in the form:

Metadata Data Object:

Measurement Properties:

Beginning Phrase:

Minimum Value:

Maximum Value:

Increment: Bilateral:

Units:

Default Value:

Using the metadata data object, a medical thought or idea can be represented. For example, if the medical object is “pulses”, the user interface may have a data structure in the form:

Medical Object:

Pulses->carotid

Properties: Beginning

Phrase: Carotid pulses are

Minimum Value: 0

Maximum Value: 4

Increment: 0

Units: /4

Bilateral: Yes

Default Value: 2

A dialog box that would be displayed on the user interface to allow the user or healthcare provider to input or select information to generate a patient note on the pulses of a patient is shown in FIG. 2. Input or selection of data with the user interface produces patient object data as well as a syntactically correct and complete medical thought. Using the data from the dialog bog of FIG. 2, the sentence “Carotid pulses are 2/4 bilateral.” is produced. If the patient's name is Jane Smith, the data of the examination is Jan. 1, 2005, the patient object data generated would be as follows:

Patient Object Data:

Object: Pulses->carotid

Patient: Jane Smith

Date: 2005-01-01

Left: 2

Right: 2

Text: Carotid pulses are 2/4 bilateral.

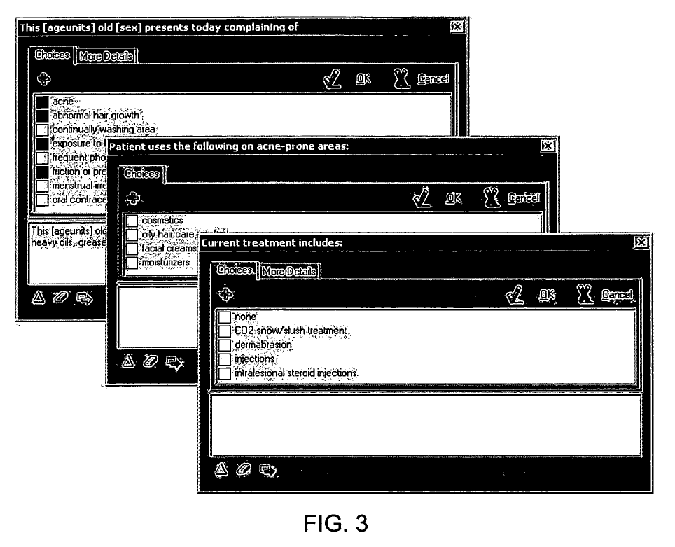

The present invention is applicable in the case where a user in filling out his or her templates always launches a particular object if another object has already been selected. For example, if the user always uses the Acne-Aggravating Factors history of present illness (HPI) and Current Treatment objects when he or she launches the Acne chief complaint, the display would appear as in FIG. 3. In the past, each object had to be launched individually. With linked objects functionality however, objects are hooked together so they automatically launch, allowing the user to select appropriate choices in a variety of scenarios quickly and easily. Linked object functionality also allows the user to link to specific choices of an object.

The linked object functionality works for linking most object classes together. If a user wants an object to launch regardless of what choice is made, the object is linked to an entire object as described in the Linking Objects to Objects section. If a user wants an object to launch only when a specific choice is made, this is described in the Linking Objects to Choices section.

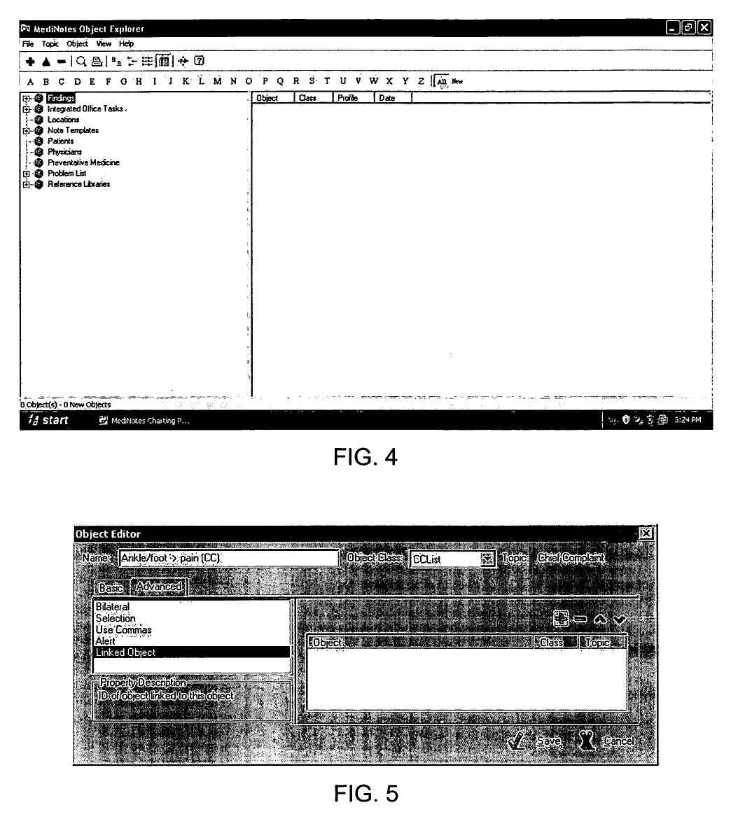

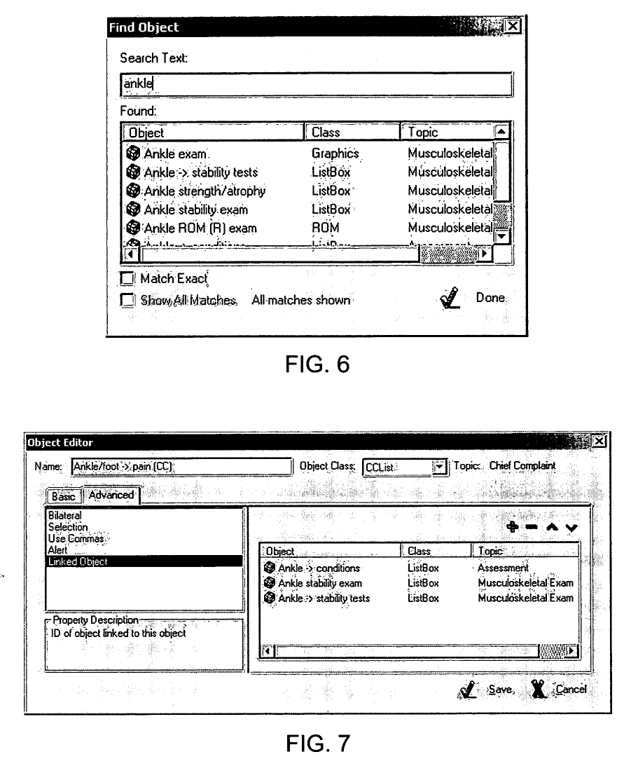

Linking Objects to Objects
1. In Object Explorer (FIG. 4), the user selects the object he or she wishes to edit and link another object to it so that it will automatically be launched. The object is launched by double-clicking it, generating the Object Editor dialog box (FIG. 5).
2. Once launched, the user clicks the Advanced tab in Object Editor dialog box (FIG. 5). Once there, the user clicks the Linked Object in the left pane once to highlight it.
3. The user then presses the New icon (represented by a cross in FIG. 5) above the right pane to generate the Find Object dialog box (FIG. 6).
4. In the Search Text pane of the Find Object dialog box (FIG. 6), the user begins typing the first few letters of the object that the user is wishing to link. In this example, the user is linking “ankle.” If, while searching, the user does not find the object the user is looking for, that object class is most likely not able to be linked to. The user should check the spelling and make sure the Match Exact box is not checked (FIG. 6).
5. The user then selects the appropriate object by double-clicking it or by clicking it once to highlight it and pressing Done.
6. Repeat steps 3 through 5 to link as many objects as necessary. In the present example, the user has selected three objects, Ankle->condition, Ankle stability exam, and Ankle->stability tests. When finished, the Object Editor view will be similar to FIG. 7.
7. The user can arrange the objects in the order desired to launch with the up and down arrows. Simply highlight the object to move by clicking it once. Then use the up or down arrows to move it to its proper location.
8. When finished linking objects, click Save. Pressing Cancel will close the Object Editor without saving changes.

Linking Objects to Choices

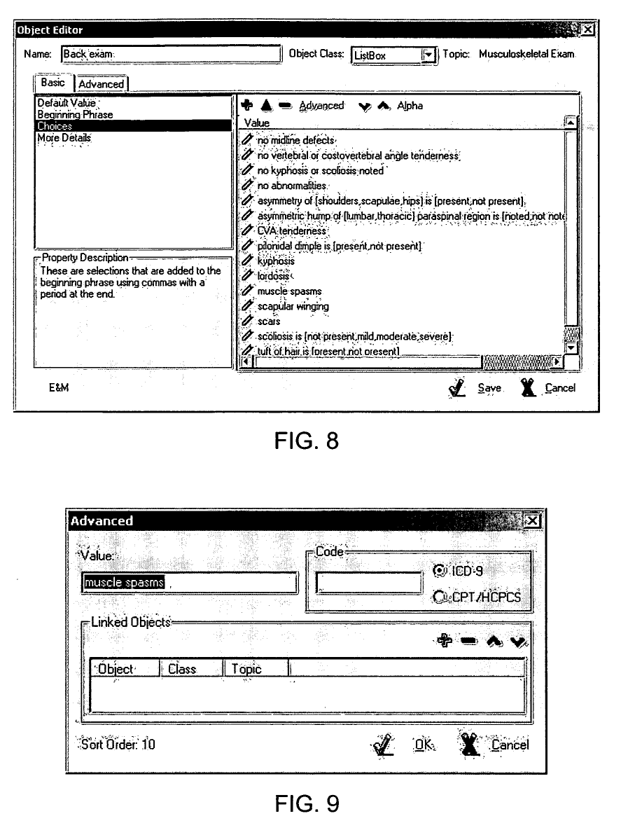

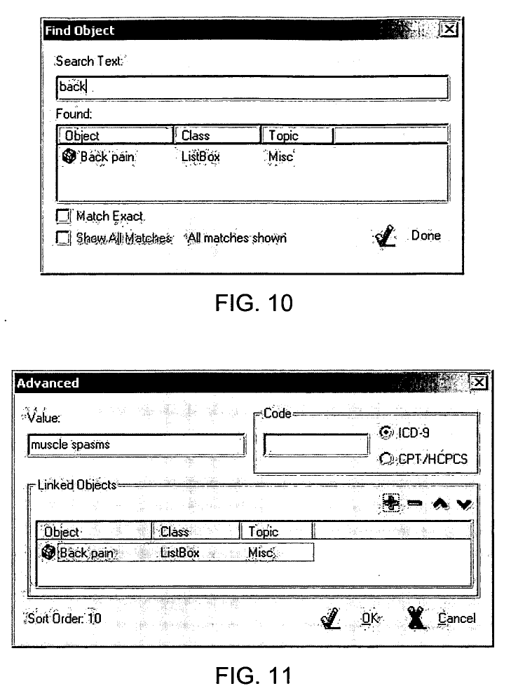

Objects can also be linked to certain object choices. In the example below, the back pain listbox is linked to the muscle spasms choice. So, when the Back Exam object is launched and the muscle spasms choice is chosen, the backpain listbox will automatically launch. However, if any of the other choices are selected, the back exam object will not launch. If a user wants an object to launch regardless of what choice is made, he or she will want to link an object to an entire object as described previously.
1. The linked object functionality works for linking most objects classes together.
2. In Object Explorer (FIG. 5), the user selects the object he or she wishes to link something to. That object is edited by double-clicking it to generate the Object Editor dialog box (FIG. 8).
3. Once launched, click the Choices selection in the Basic tab of Object Editor (FIG. 8).
4. Select the choice it is desired to link to by clicking it once to highlight it. Press the Advanced button above the choice pane to launch the Advanced dialog box (FIG. 9).
5. Press the New icon in the Linked Objects pane of the Advanced dialog box to open the Find Object dialog box (FIG. 10).
6. In the Search Text pane of the Find Object dialog box (FIG. 10), the user begins by typing the first few letters of the desired object to be linked. In this example, the user is searching for “back.” If, while searching, the object is not found, that object class is most likely not able to be linked to. Check the spelling and make sure the Match Exact box is not checked.
7. Select the appropriate object (in this example, “Back pain”) by double-clicking it or by clicking it once to highlight it and pressing Done. The selected object is now displayed in the Advanced dialog box (FIG. 11).
8. Repeat steps 3 through 6 to link as many objects to choices as desired.
9. Arrange the objects in the order desired to launch with the up and down arrows. Simply highlight the object to move by clicking it once. Then use the up or down arrows to move it to its proper location.
10. When finished linking objects, click Save. Pressing Cancel will close the Object Editor without saving changes.

Linking from a Chief Complaint

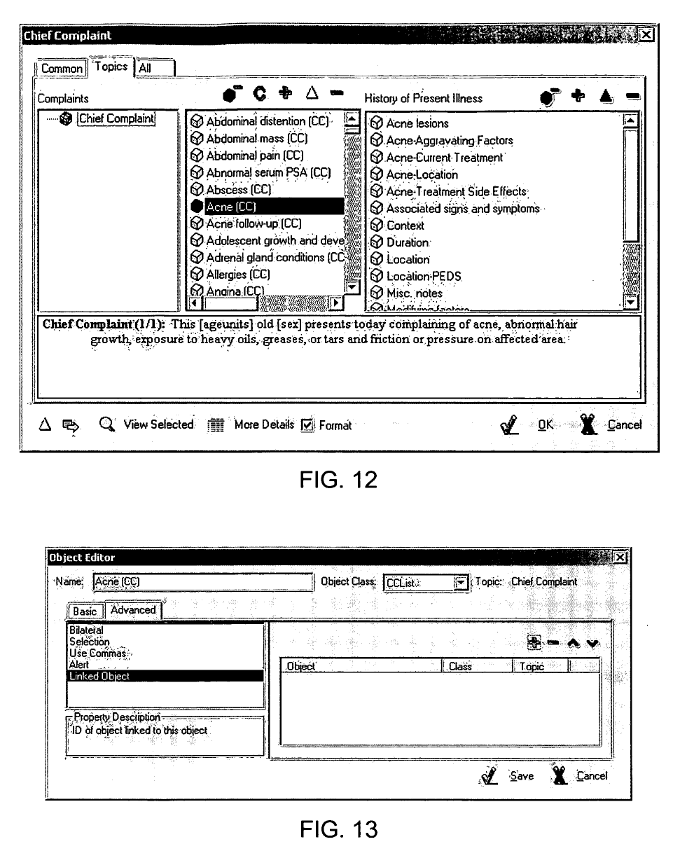

Linking histories of present illnesses (HPIs) to chief complaints is one of the main functionalities of the present invention, and represents a specific example of the linking objects to objects functionality. Typically, every chief complaint has some HPI data associated with it. In the past, a user had to launch each HPI the user wanted to fill out one at a time. Now, the user can link the HPIs to the chief complaint and arrange them in the order that the user wishes to use them in. In a note, the user must essentially launch the chief complaint twice. First, the user must launch the chief complaint object in the note (by double-clicking). However, to launch the string of linked objects associated with the chief complaint, the user must also double-click it inside the Chief Complaint container (FIG. 12). The reason the user must launch them from inside the container is to avoid having to go through multiple sets of links if the user happens to have several chief complaints associated with the same note and all those chief complaints have objects linked to them. When that chief complaint is launched, the HPIs will launch in order automatically, saving time.

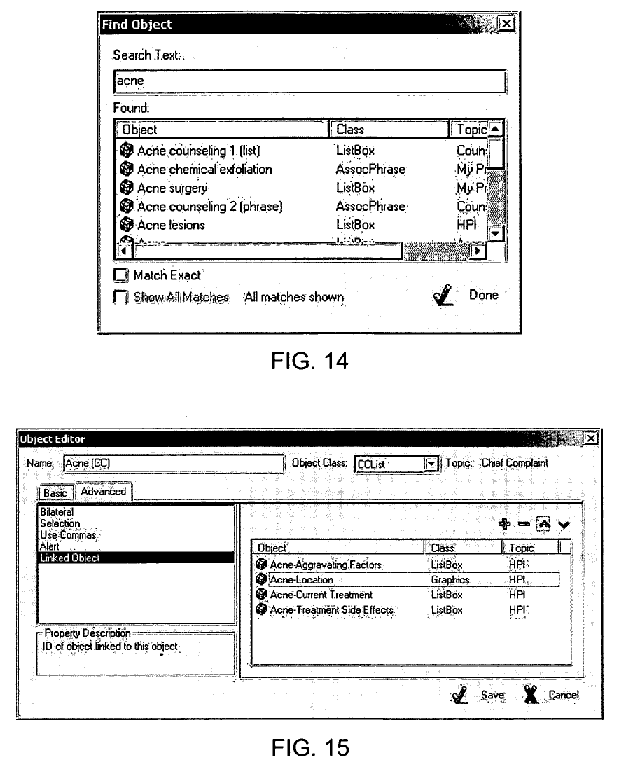

To link a history of present illness (HPI) to a chief complaint:
1. In Object Explorer (FIG. 4), select Findings>History>Chief Complaint. A list of the available chief complaints will appear in the pane to the right (FIG. 12).
2. Select and launch the appropriate chief complaint by double-clicking it.
3. Once launched, click the Advanced tab in Object Editor. Once there, click Linked Object in the left pane once to highlight it (FIG. 13).
4. Press the New icon above the right pane.
5. In the Search Text pane of the Find Object dialog, begin typing the first few letters of the HPI you are wishing to link (FIG. 14). If, while searching, the desired object is not found, that object class is most likely not able to be linked to. Check the spelling and make sure the Match Exact box is not checked.
6. Select the appropriate HPI by double-clicking it or by clicking it once to highlight it and pressing Done.
7. Repeat steps 4 through 6 to link as many HPIs as necessary. When finished, the Object Editor view will be similar to FIG. 15.
8. Arrange the HPIs accordingly with the blue up and down arrows. Simply highlight the HPI to move by clicking it once. Then use the up or down arrows to move it to its proper location.
9. When finished linking HPIs, click Save. Pressing Cancel will close the Object Editor without saving changes.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

We claim:

1. A computer software application using object-oriented programming for generating medical documents, comprising:
(a) metadata objects used to represent user-interface components;
(b) medical objects based on the metadata objects;
(c) patient data objects generated from medical objects as selected by a user;
(d) a relational database for storing and retrieving the metadata objects, the medical objects and the patient data objects; and
(e) means for linking a metadata object to one or more other objects creating linked objects such that the linked objects are launched automatically upon launch of the metadata object.

2. A computer software application as defined in claim 1, wherein the metadata object has at least one user-selected option and a selected one of the linked objects is launched only upon choice of the option by the user.
